(19) United States
(12) Patent Application Publication
(10) Pub. No.: US 2008/0208602 A1
(43) Pub. Date: Aug. 28, 2008

(54) Method and apparatus for an on-line building registry and organizer

(76) Inventor: W. Gary Westernoff, Moraga, CA (US)

Correspondence Address: KRISTIN C. CASTLE, 96 OAKMONT AVENUE, PIEDMONT, CA, 94610, US

(21) Appl. No.: 11/651,421

(22) Filed: Jan. 9, 2007

(51) Int. Cl. G06F 3/048

(52) U.S. Cl. 705/1

(57) ABSTRACT

The invention comprises a method of automated registering of a professional contractor comprising the steps of logging on to a website, wherein a program on a website displays a series links including choosing to register a building process project from the series of links; registering the project within a provider server data base, wherein the data base contains all information for every project registered; determining whether to register a professional for the project, wherein if a user decides not to register the professional, the user still can register the project; registering the professional, wherein all information regarding the professional goes into the data base; determining not to register the professional and continuing with the program; receiving analysis results from the analysis engine, wherein the analysis results are based at least in part from data received from on one or a plurality of users registering professionals on the website; and providing data to the provider server based on the analysis results.

The invention also comprises a method of automated data collection and construction management organization from a user comprising the steps of: receiving a request from a user machine to access an internet Web site having a program including a series of options including an organizer, wherein the Web site displays a menu which includes a project organizer; providing a building process project organizer wherein when the user opens the organizer, a data sheet is provided for the user to complete for each project the user opens; and providing a number for each saved project such that when a user opens the saved project a menu appears having all the project information and includes information and links for all phases of the building process project and wherein the user can switch between a phase view and a topic view of the building process project.

### FIELD

The present invention generally relates to the construction field. More specifically, the invention relates to method and apparatus for an automated building construction projects registry and construction building organizer.

### BACKGROUND

The approaches described in this section could be pursued, but are not necessarily approaches that have been previously conceived or pursued. Therefore, unless otherwise indicated herein, the approaches described in this section are not prior art by inclusion to the claims in this application and are not admitted prior art by the inclusion in this section.

With improving technologies in telephone communication, television broadcasting, and the Internet marketplace, many new concepts have been created in the areas of the construction industry.

Trends will continue to be dictated by advancements in technology. The difficulty in using the internet for an industry such as the construction industry arises from the many complex issues that arise during any project and any phase of any project. Some websites, for example in U.S. Pat. No. 7,096,223 to Cope describes a method of matching buyers and sellers to improve cost efficiency. This cost efficiency is achieved through what is like a bidding process, where the buyer displays on-line the quantities of a material he wants and a price they are willing to pay. A seller then has the option of accepting the offer.

Another problem with building construction sites is that they are mainly designed for the professional. An owner builder, individual, beginning contractor or even an experienced contractor who would like to see the rating of a professional does not have a one-stop shopping site.

Herein the difficulties lie; there is no ability for performance reporting of professionals. The inability of an individual or a beginning contractor or even an experienced contractor who would like to be able to go to a site where professionals have been registered and rated is lacking. In addition, in most cases most individuals or beginning contractors—even some experienced contractors—are not aware of the complex nature of organizing a construction project. In addition, a person may be granted a certificate course in building management through using this site and completing the required forms. This invention fills needs described above.

### BRIEF DESCRIPTION OF THE DRAWINGS

FIG. 1 is a block diagram that depicts an example system for automated data collection and analysis according to one embodiment of the invention.

FIG. 2 is a flowchart that depicts a process for registering a project and/or a professional according to the invention.

FIG. 3 is a flowchart that depicts a process for organizing building data according to the invention.

FIG. 4 is a block diagram that illustrates a computer system upon which an embodiment of the invention may be implemented.

### DETAILED DESCRIPTION

A method and apparatus for automated data collection and analysis is described. In the following description, for the purposes of explanation, numerous specific details are set forth in order to provide a thorough understanding of the present invention. It will be apparent, however, to one skilled in the art, that the present invention may be practiced without these specific details. In other instances, well-known structures and devices are shown in block diagram form in order to avoid unnecessarily obscuring the present invention.

Embodiments are described herein according to the following outline:

1.0 Definitions

2.0 General Overview

3.0 Functional Overview

4.0 Hardware Overview

5.0 Extensions and Alternatives

1.0 Definitions

“Internet Protocol” is defined as an IP address which is a numeric address that is used to identify a network interface on a specific network or subnetwork. Every computer or server on the Internet has an IP address. It is a unique number consisting of four parts separated by dots. For example, 198.204.112.1. The address contains two pieces of information: the network portion, known as the IP network address, and the local portion, known as the local or host address.

An “Internet Service Provider” is defined as a An ISP (Internet service provider) is a company that provides individuals and other companies access to the Internet and other related services such as Web site building and virtual hosting. An ISP has the equipment and the telecommunication line access required to have a point-of-presence on the Internet for the geographic area served. The larger ISPs have their own high-speed leased lines so that they are less dependent on the telecommunication providers and can provide better service to their customers. Among the largest national and regional ISPs are AT&T WorldNet, IBM Global Network, MCI, Netcom, UUNet, and PSINet.

The “Internet” is defined is a worldwide system of computer networks - a network of networks in which users at any one computer can, if they have permission, get information from any other computer (and sometimes talk directly to users at other computers). It was conceived by the Advanced Research Projects Agency (ARPA) of the U.S. government in 1969 and was first known as the ARPANET. The original aim was to create a network that would allow users of a research computer at one university to be able to “talk to” research computers at other universities. A side benefit of ARPANet's design was that, because messages could be routed or rerouted in more than one direction, the network could continue to function even if parts of it were destroyed in the event of a military attack or other disaster.

SQL (commonly expanded to Structured Query Language—see History for the term's derivation) is the most popular computer language used to create, modify, retrieve and manipulate data from relational database management systems. The language has evolved beyond its original purpose to support object-relational database management systems. It is an ANSI/ISO standard.

SQL is commonly spoken either as the names of the letters ess-cue-el, or like the word sequel. Concerning the names of major database products (or projects) containing the letters SQL, each has its own convention: MySQL is officially and commonly pronounced “My Ess Cue El”; PostgreSQL is expediently pronounced postgres (which had been the predecessor to PostgreSQL); and Microsoft SQL Server is commonly spoken as Microsoft-sequel-server.

SQL is designed for a specific, limited purpose—querying data contained in a relational database. As such, it is a set-based, declarative computer language rather than an imperative language such as C or BASIC which, being general-purpose, are designed to solve a much broader set of problems. Extensions to and variations of the standards exist: Oracle Corporation's PL/SQL, IBM's SQL PL (SQL Procedural Language) and Sybase/Microsoft's Transact-SQL, which are of a proprietary nature.

Language extensions such as PL/SQL bridge this gap to some extent by adding procedural elements, such as flow-of-control constructs. Another approach is to allow programming language code to be embedded in and interact with the database. For example, Oracle and others include Java in the database, and SQL Server 2005 allows any NET language to be hosted within the database server process, while PostgreSQL allows functions to be written in a wide variety of languages, including Perl, Tcl, and C.

“Open Source Software” is defined as software for which the underlying programming code is available to the users so that they may read it, make changes to it, and build new versions of the software incorporating their changes. There are many types of Open Source Software, mainly differing in the licensing term under which (altered) copies of the source code may (or must be) redistributed.

“Hypertext Markup Language” is defined as the basic language used to write web pages. HTML is a mark up language and not a full-blown programming language so is therefore essentially static in nature. HTML is parsed by your web browser when a web page downloads and consists of tags (commands to tell the browser how to render the text, where to load in graphics etc on the web page) as well as the actual text. It is a subset of Standard Generalized Markup Language (SGML), this language provides codes used to format hypertext documents. Individual codes are used to define the hierarchy and nature of various components of a document, as well as to specify hyperlinks.

A “MySQL database” is defined as MySQL is a multithreaded, multi-user, SQL Database Management System (DBMS) with more than six million installations. MySQL AB makes MySQL Server available as free software under the GNU General Public License (GPL), but they also offer the MySQL Enterprise subscription offering for business users and dual-license it under traditional proprietary licensing arrangements for cases where the intended use is incompatible with the GPL.

An “Application Programming Interface” (API), the interface (calling conventions) by which an application program accesses operating system and other services, is defined at source code level and provides a level of abstraction between the application and the kernel (or other privileged utilities) to ensure the portability of the code. There are APIs available that allow applications written in numerous programming languages to access MySQL databases, including: C, C++, C#, Borland Delphi (via dbExpress), Eiffel, Smalltalk, Java (with a native Java driver implementation), Lisp, Perl, PHP, Python, Ruby, REALbasic (Mac), FreeBasic, and Tcl; each of these uses a specific API. An ODBC interface called MyODBC allows additional programming languages that support the ODBC interface to communicate with a MySQL database, such as ASP or Coldfusion. MySQL is mostly implemented in ANSI C.

MySQL is popular for web applications such as MediaWiki or Drupal and acts as the database component of the LAMP, MAMP and WAMP platforms (Linux/Mac/Windows-Apache-MySQL-PHP/Perl/Python), and for open-source bug tracking tools like Bugzilla.

To administer MySQL databases one can use the included command-line tool (commands: mysql and mysqladmin). Also downloadable from the MySQL site are GUI administration tools: MySQL Administrator and MySQL Query Browser. Both of the GUI tools are now included in one package called MySQL GUI Tools. A widespread and popular alternative, written in PHP, is the free software web application phpMyAdmin.

A “Hypertext Preprocessor” (PHP) is defined as an open source server side programming language extensively used for web scripts and to process data passed via the Common Gateway Interface from HTML forms etc. PHP can be written as scripts that reside on the server and may produce HTML output that downloads to the web browser. Alternatively, PHP can be embedded within HTML pages that are then saved with a .php file extension. The PHP sections of the page are then parsed by the PHP engine on the server and the PHP code stripped out before the page is downloaded to the web browser.

A “Query” is defined as a word, phrase or group of words characterizing the information a user seeks from search engines and directories. The search engine subsequently locates Web pages to match the query.

“Javascript” is defined as a type of Scripting language (originally called LiveScript) developed by Netscape Communications for use with the Navigator browser. JavaScript code forms part of the HTML page and can be used for example to respond to user actions such as button clicks or to run processes locally or validate data.

A “Wireless Network” allows computers to share printers, files or an internet connection without any wires between them. Wireless networking hardware uses radio frequencies to transmit information between the individual computers; each computer requires a wireless network adapter. A wireless network hub or router is used to bridge the wireless network to traditional ethernet or home phone line networks, or provide a shared internet connection.

“Dial-up Access” is an inexpensive but relatively slow form of internet access in which the client uses a modem to dial the internet service provider's node, a dialup server type such as the PPP and TCP/IP protocols to establish a modem-to-modem link, which is then routed to the internet. It is now legacy technology in the advent of widely available broadband internet access in the Western World.

A “LAN” or a “local area network” is a computer network limited to the immediate area, usually the same building or floor of a building. LANs are capable of transmitting data at very fast rates, much faster than the data that is transmitted to you over the Internet; there is no limit on the number of computers that can be attached to a single LAN.

A “WAN” or a “wide area network” is a geographically dispersed telecommunications network. The term distinguishes a broader telecommunication structure from a local area network. A wide area network may be privately owned or rented, but the term usually connotes the inclusion of public (shared user) networks. An intermediate form of network in terms of geography is a metropolitan area network (MAN).

“Client” is defined as the requesting program or user in a client/server relationship. For example, the user of a Web browser is effectively making client requests for pages from servers all over the Web. The browser itself is a client in its relationship with the computer that is getting and returning the requested HTML file. The computer handling the request and sending back the HTML file is a server.

“Users” are defined as people using or accessing the WWW. Could also refer to people accessing a specific web site or web page, in this case the user is the same as a visitor or customer.

“World Wide Web Consortium” (W3C ) is an international consortium of companies involved with the Internet and the Web. The W3C was founded in 1994 by Tim Berners-Lee, the original architect of the World Wide Web. The organization's purpose is to develop open standards so that the Web evolves in a single direction rather than being splintered among competing factions. The W3C is the chief standards body for HTTP and HTML.

A “Project” is defined as a word used to represent the overall scope of work being performed to complete a specific construction job.

“Construction” is defined as the act or process of constructing.

“Building Process” is defined as a term used to express every step of the of a construction project from its conception to its final acceptance and occupancy.

“My Project Organizer” is defined as an on-line tool used for the building process having in it every item needed to complete every step of the of a construction project from its conception to its final acceptance and occupancy.

“Professional” is defined as the service providing party including, but not necessarily limited to, architects; planners; designers; contractors; subcontractors; engineers; handyman services; bonding and insurance companies; construction and equity lenders, attorneys; real estate agents and property managers; project managers; construction managers; local and national construction related regulatory agencies and organizations.

A “Resource” is defined as any person or industry including, but not limited to, the service providing party including, but not necessarily limited to, vendors, retailers, and wholesalers of various building construction related products such as material, equipment or suppliers.

A “Subcontractor” is defined as any person including, but not limited to, electricians, plumbers, heating and ventilating, painting, carpenters, designers, engineers, planners, etc.

2.0 Structural Overview

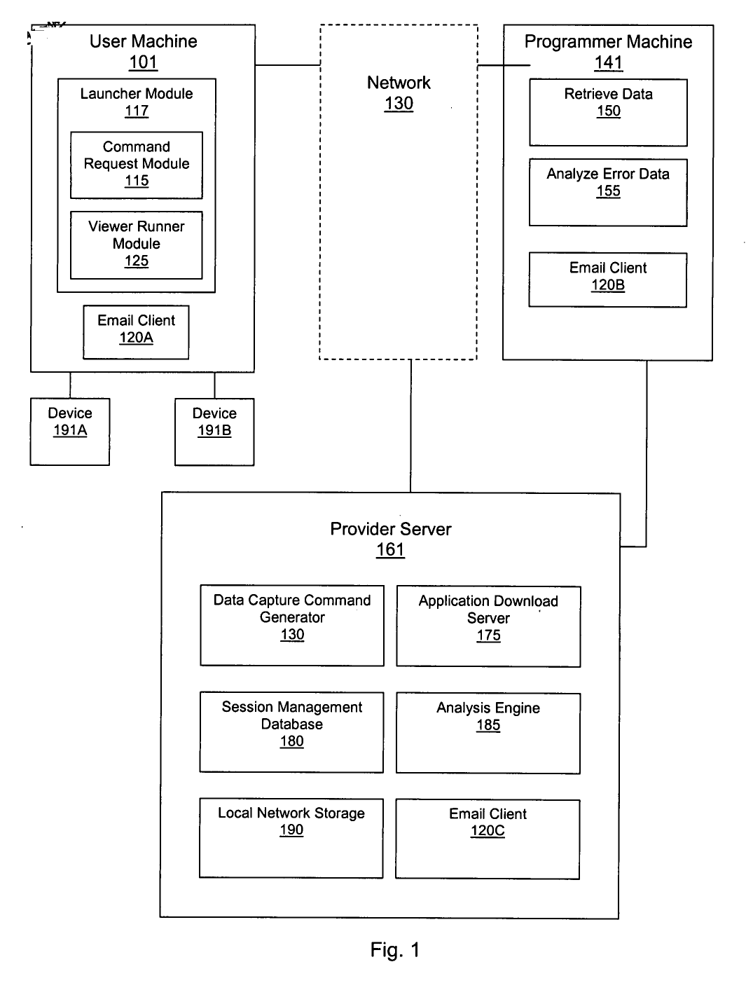

FIG. 1 is a block diagram that depicts an example system for building process registry and the building process management organizer according to one embodiment of the invention.

User machine 101 is communicatively coupled to network 130 and devices 191A and 191B. In one embodiment, programmer machine 141 and provider server 161 are also communicatively coupled to network 130 and to one another. In another embodiment, programmer machine 141 and provider server 161 may be one and the same. In various embodiments, the network 130 is a wireless network, a dial-up access, the internet, a LAN, a WAN or any other communications network known now or developed in the future.

User machine 101, programmer machine 141, devices 191A and 191B and provider server 161 are each logical machines. Each logical machine can run on separate physical computing machines or can be running on the same physical computing machine as one or more of the other logical machines. Various embodiments of computers and other machines are described in detail below in the section entitled Hardware Overview. In various embodiments, devices 191A and 191B are routers, switches, hubs, and any other appropriate routing devices.

User machine 101 comprises a launcher module 110 and an email client module 120A. In one embodiment, the launcher module 110 is one or more software elements running on the user machine 101. In various embodiments, the launcher module 110 is written in Java, Perl, C++, FORTRAN, Pascal, or any other appropriate language. In various embodiments, the launcher module 110 is Java Web Start.TM., an application that can execute Java Network Launching Protocol.TM. (“JNLP”) files, a proprietary launcher application, or any other appropriate launcher mechanism. In various embodiments, the launcher module 110 can execute sets of commands including data capture commands, send and receive commands using appropriate communication mechanisms, or commands to make the launcher module 110 pause for a predefined period of time.

In one embodiment, launcher module 110 comprises a command runner module 115. In various related embodiments, command runner module 115 is a program running on user machine 101 as part of launcher module 110 or separately from launcher module 110. In various embodiments, command runner module 115 is written in PHP, Java, Perl, C++, FORTRAN, Pascal, or any other appropriate language. In various embodiments, command runner module 115 is a Java Web Start.TM. application, an application that can execute JNLP files, an application that started by executing a JNLP file, a proprietary command running application, or any other appropriate command running mechanism. In various embodiments, command runner module 115 executes sets of commands including data capture commands, send and receive commands using appropriate communication mechanisms, or commands to make command runner module 115 pause for a predefined period of time.

In one embodiment, launcher module comprises viewer runner module 125. In various related embodiments, viewer runner module 125 is a program running on user machine 101 as part of launcher module 110 or separately from launcher module 110. In various embodiments, viewer runner module 115 is written in Java, Perl, C++, FORTRAN, Pascal, or any other appropriate language. Viewer runner module 125 allows for the program by the users. For example, each page may be in, including but not limited to, an HTML format.

In one embodiment, the email client modules 120A, 120B are programs that can send and receive email using appropriate communication means. In various embodiments, the email client modules 120A, 120B are programs that can render email documents written as unformatted text or in a structured format such as hypertext markup language (HTML), extensible markup language (XML), portable document format (PDF), or postscript (PS).

The Programmer machine 141 may comprise retrieve data module 150, analysis data module and email client module 120B. Various embodiments of email client module 120B are described above. In various embodiments, data capture command generator module 155 is a program running on the Programmer machine 141, a program running on a machine communicatively coupled to Programmer machine 141, or a module running as part of a program which is running either on Analysis machine 141 or a machine thereto communicatively coupled. In various embodiments, analysis data module 155 is a program running on Programmer machine 141, a program running on a machine communicatively coupled to Programmer machine 141, or a module running as part of a program which is running either on Programmer machine 141 or a machine thereto communicatively coupled. As is known to one of ordinary skill in the art, the invention is directed to method and apparatus of marketing and advertising, the Programmer machine 141 may be designed to be specifically tailored for the needs of the Programmer and set forth for exemplary purposes only. Programmer machine 141 may be a part of provider server 161 and is just one exemplary embodiment described above.

Provider server 161 comprises data capture command generator 170, application download server 175, session management database 180, an analysis engine module 185, local/network storage module 190 and email client module 120C. Various embodiments of email client module 120B are described above.

In various embodiments, data capture command generator module 170 is a program running on provider server 161, a program running on a machine communicatively coupled to provider server 161, or a module running as part of a program which is running either on provider server 161 or a machine thereto communicatively coupled.

In various embodiments, application download server module 175 is a program running on the provider server 161, a program running on a machine communicatively coupled to the provider server 161, or a subroutine running in a program which is running on the provider server 161 or a machine thereto communicatively coupled. In various embodiments, application download server module 175 includes a file transfer protocol (FTP) server, a hypertext transfer protocol (HTTP) server, a secure HTTP (HTTPS) server, a TCP/IP socket, or any other appropriate communication mechanism.

In various embodiments, session management database server 180 is a program running on a machine communicatively coupled to the provider server 161, or a subroutine running in a program which is running on the provider server 161 or a machine thereto communicatively coupled. In various embodiments, session management database server 180 includes one or a plurality of server modules, database modes and one or more management server modules which handle the system configuration and are used to change the configuration of the system.

In various embodiments, analysis engine module 185 is a program running on provider server 161, a program running on a machine communicatively coupled to provider server 161, or a module running in a program which is running on provider server 161 or a machine thereto communicatively coupled. In various embodiments, analysis engine module 185 is an expert system, a rule-based engine, a rule-based markup language (RBML) engine, or any other appropriate analysis engine.

In various embodiments, local/networked storage module 190 is a program running on provider server 161, a program running on a machine communicatively coupled to provider server 161, or a module running in a program which is running on provider server 161 or a machine thereto communicatively coupled.

3.0 Functional Overview

The present invention focuses on reporting the performance of the methods and materials of the construction process. The invention works at simplified level of the construction process. The present invention provides a platform for buyers and sellers to work from for their mutual benefit. Simply put, if a seller performs well on a project, the invention provides a Web-based platform for reporting and a positive report will result and more business could be realized and the buyer will be satisfied and would most likely use the seller again; but if the seller performs poorly a negative report will result and less business could be realized and the buyer will not be satisfied and may not use the seller again.

This invention also provides a Web-based platform for construction based planning and organization. This organizer, referred to, for example, as My Project Organizer is complete and thorough organizer for the user who has never undertaken a construction project to a seasoned professional who needs organization in his business. This invention also provides an educational aspect for individuals or contractors who would like to gain education in their field through a low-cost on-line program.

In one aspect of the invention a reporting process is disclosed. In this aspect, a user logs onto the Web site wherein the user then clicks on Register A Project. During the registration process, a menu asks the user whether they would like to register the professional that is working on the project. If the user decides to register the professional, the user is led to another menu where they are required to pay a fee for registration. The registration of the project and/or the professional is a benefit to all potential users of the Web site. For example, the registration provides information including, but not limited to, the complete project history, the quality of work, whether the professional completes work on schedule, licensing of the professional, etc. As such, the invention reports specific projects to third parties such as, but not necessarily limited to, insurance companies, building departments, environmental protection agencies, etc. This provides an enormous benefit, not only to the novice contractor or homeowner, but also government agencies that need reliable information on contractors.

This invention also focuses on establishing a methodology for establishing and maintaining quality assurance and minimizing construction deficiencies by making hired professionals and resources accountable for their actions.

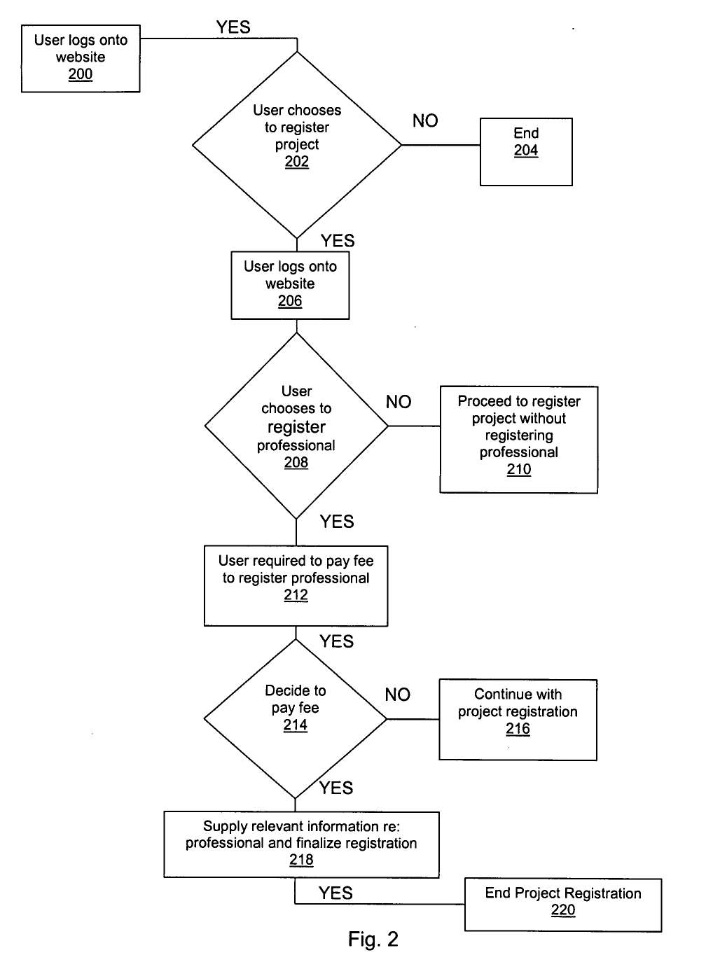

FIG. 2 is a flowchart that depicts a process for registering a professional according to the invention. At step 200, a user logs onto a Web site. The Web site is a general construction management Web site comprising information designed to be the ultimate self-help guide and source on discovering the secrets of fast and easy do it yourself construction management for any size project.

Construction management is ability to understand the building process, as defined as every step of the of a construction project from its conception to its final acceptance and occupancy. As one of ordinary skill in the art can readily recognize this is a very difficult task, especially for a novice builder or a homeowner that wants to do a “do it yourself” project and even for a seasoned professional. The program can be a software program. Once the user is on Web site at step 200, there are several menu choices available to the user. One menu choice is to register a project. At step 202, the user chooses whether or not to register the project. The project registration is a free service and, therefore is beneficial to the user regardless of the project. If at step 204, the user decides not to register the project, this part of the construction management program ends. The user then may go back to the main menu for other options. If at step 206, the user decides to register the project, the user simply fills in the form containing the project details to register the project. At step 206, the user reaches a point in the form that asks whether the user would like to register the professional or resource associated with the project. If the user decides not to register the professional or resource at step 210, the user continues with the project registration. If, however, at step 212, the user decides to register the professional or resource, the user is redirected to another screen requiring the user to pay a small fee to register the professional or resource. If the user decides not to pay the fee, again, the project registration is finished at step 216. However, if the user pays the fee at step 214, the user is directed to a drop down menu at step 218. At step 218, the user fills in all relevant information regarding the professional or resource. This information is filled in as the project is underway and is not fully complete until the building process is complete. This is because the performance of the professional or resource cannot be determined fully until the building process is completely done. At step 220, the project and building process are complete and the program ends. The professional or resource is fully registered for future reference.

In another embodiment, there can be several projects for one building, for example, such as and addition, plumbing, electrical wiring, etc. In the present invention, each project has to be registered and given a unique number. In addition, for each project there may be more than one professional or resource, each of whom would need to be registered. The data base may then pull the projects up by address, type of work done, type of professional, etc.

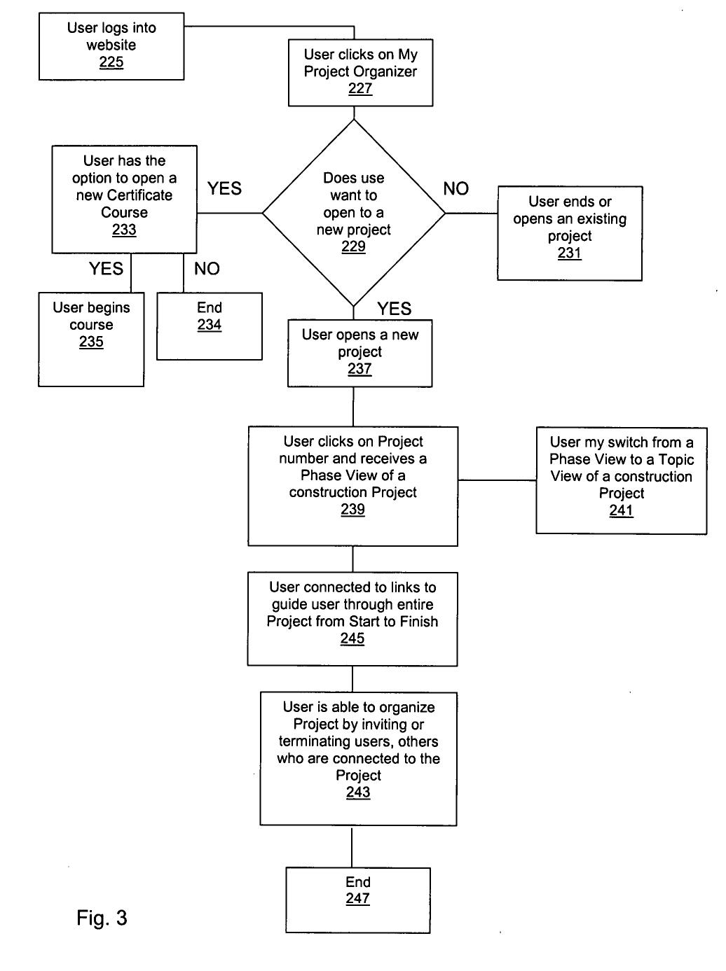

FIG. 3 is a flowchart that depicts a process for organizing building process data according to the invention. As set forth above, construction management is ability to understand the building process, as defined above as every step of the of a construction project from its conception to its final acceptance and occupancy. As one of ordinary skill in the art can readily recognize this is a very difficult task, especially for a novice builder or a homeowner that wants to do a “do it yourself” project and even for a seasoned professional. The building process organizer set forth in this invention solves the problems in the very difficult building process by organizing either by a phase or topic view and setting forth almost every possible question, answer for example including, but not limited to, forms, budget calculators, insurance calculators, estimates, the ability to post Requests for Proposal, (“RFP”), inspection reports, etc. All of which will be discussed in detail below.

As shown in FIG. 3, at step 225 a user logs on to a Web site. The Web site is a general construction management Web site comprising information designed to be the ultimate self-help guide and source on discovering the secrets of fast and easy do it yourself construction management for any size project. The Web site also offers educational courses in construction management that will be discussed in detail below.

The Web site is a general construction management Web site comprising information designed to be the ultimate self-help guide and source on discovering the secrets of fast and easy do it yourself construction management for any size project.

Once the user is on Web site at step 225, there are several menu choices available to the user. One of the choices is My Project Organizer. At step 227, the user clicks on My Project Organizer and a new page opens.

In one embodiment, this page is specific to user only accessible by the user's identification and password. Once the page is open, the user has the options of opening a new project, opening a certificate program (i.e. the educational course offered in construction management) or opening a project that the user has already created. The user may have several projects already created. The projects are open until the building process is complete or the user decides that they no longer wish to pursue the project. The user may store as many projects in the data base that they would like to.

At step 229, the user determines whether they want to open a new project. If they determine they do not want to open a new project at that time, they can either close the window or open an existing program at step 231. All programs that have been opened are stored on this page.

In addition, at step 233 the user has the option to open a new certificate course. In this option, the user may obtain a certificate in construction management by satisfying the requirements. At step 234, if the user decides not to start the course the program ends. If the user decides to start the certificate course, the user begins the course at step at 235.

Next at step 237, the user has decided to open a new project. The user clicks on “open a new project” and a new page opens. At 237, a page opens asking the user to create a new project. The user is asked for a project number, name, description, address, classification, start date and finish date. Once this information is entered, the user clicks on open project. A new screen comes up congratulating the user on opening a new project and prompting the user to return to the project list. Once the user returns to the project list, the user clicks on a created project number at step 239 and a screen appears with a phase view of the My Project Organizer.

The phase view of My Project Organizer has all the details of the project at the top of the page including the ability to edit project details or delete the project. The user can also invite other users to the project, terminate other users to the project or email other users. Other users may be invited as team members and given a status. For example, the coordinator creates the project and has full control over the project, team members have some ability to make changes, and observers observe.

The Phase View has several categories including, but not limited to, project calendar, documents and management; schematic design and scope of work phase; design development and budgeting phase; contract documents and review phase; bidding, estimating and negotiating phase; construction phase; and hiring professionals phase.

Each category has several links underneath to help organize every aspect of the building process. The project calendar, documents and management category has links including, but not limited to, project calendar, assign tasks to team members, manage files and documents, projects favorites, project message board and project information. The schematic design and scope of work phase has links including, but not limited to, planning questions, management questions, and basic questions. The design development and budgeting phase has links including, but not limited to, insurance calculator, budget calculator, and about bonding. The contract documents and review phase has links including, but not limited to, drawing review checklist, guarding against liens, and site plan review check list. The bidding, estimating and negotiating phase has links including, but not limited to, general requirements, type of work calculator, view bids and estimates, post RFPs, and post estimates. The construction phase has links including, but not limited to, construction checklist, meeting agenda, project administration, paying for performance, inspection performance and inspection reports. The hiring professionals phase has links including, but not limited to, post an ad for professionals, should I hire prime or main contractor?, screen contractors, scoring architects, engineers and design professionals, and architects, engineers and design hiring guidelines.

The user may switch from the phase view at step 239 to the Topic View at step 241. The Topic View also has several categories including, but not limited to, scheduling; collaboration; files and documentation; budgeting, estimating and calculators; bonding and insurance; productivity checklists; administrative checklists; and screening and selecting construction professionals.

Each category has several links underneath to help organize every aspect of the building process. The scheduling topic has links including, but not limited to, a project calendar and assign tasks to team members. The collaboration topic has links including, but not limited to, a project message board, projects favorites and project information. The files and documentation topic has links including, but not limited to, managing files and documentation. The budgeting, estimating and calculators topic has links including, but not limited to, posting RFPs, viewing bids and estimates, posting estimates, type of work calculators, budget calculator and general requirements. The bonding and insurance topic has links including, but not limited to, about bonding and an insurance calculator. The productivity checklists topic has links including, but not limited to, management questions, basic questions and paying for performance. The administrative checklists topic has links including, but not limited to, reviewing drawings, planning questions, site plan questions, construction checklists, meeting agendas, project administration, inspection reports and guarding against liens. The screening and selecting construction professionals topic has links including, but not limited to, post an ad for professionals, should I hire prime or main contractor?, screen contractors, scoring architects, engineers and design professionals, and architects, engineers and design hiring guidelines.

At step 243, the user is able to organize the project by inviting users and giving them a status. In doing this, emails and tasks are automatically sent depending on the status of the invitees. This simplifies the process greatly by cutting down on paper work or thinking about who gets what—the paperwork is automatically generated.

At step 245, the user uses the links and organizer discussed above to organize their project, determine the staff needed, etc. The My Project Organizer is able to help the novice to the professional though the building process.

At step 247, the project ends.

4.0 Hardware Overview

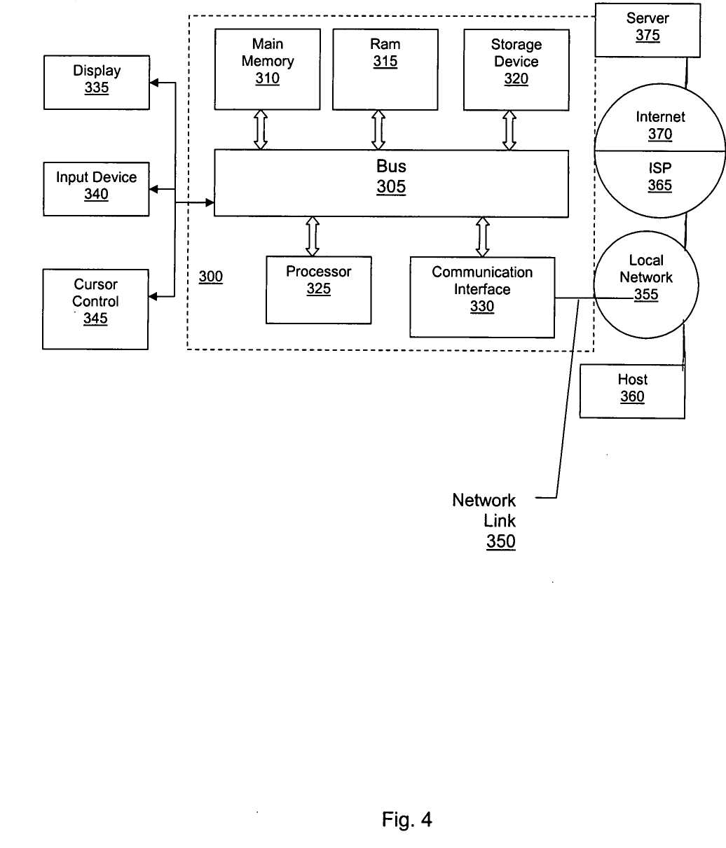

FIG. 4 is a block diagram that illustrates a computer system 300 upon which an embodiment of the invention may be implemented. Computer system 300 includes a bus 305 or other communication mechanism for communicating information, and a processor 325 coupled with bus 305 for processing information. Computer system 300 also includes a main memory 310, such as a random access memory (RAM) or other dynamic storage device, coupled to bus 305 for storing information and instructions to be executed by processor 325. Main memory 310 also may be used for storing temporary variables or other intermediate information during execution of instructions to be executed by processor 325. Computer system 300 further includes a read only memory (ROM) 315 or other static storage device coupled to bus 305 for storing static information and instructions for processor 304. A storage device 320, such as a magnetic disk or optical disk, is provided and coupled to bus 305 for storing information and instructions.

Computer system 300 may be coupled via bus 305 to a display 335, such as a cathode ray tube (CRT), for displaying information to a computer user. An input device 340, including alphanumeric and other keys, is coupled to bus 305 for communicating information and command selections to processor 325. Another type of user input device is cursor control 345, such as a mouse, a trackball, or cursor direction keys for communicating direction information and command selections to processor 304 and for controlling cursor movement on display 335. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 325 executing one or more sequences of one or more instructions contained in main memory 310. Such instructions may be read into main memory 310 from another machine-readable medium, such as storage device 320. Execution of the sequences of instructions contained in main memory 310 causes processor 325 to perform the process steps described herein. In alternative embodiments, hard-wired circuitry may be used in place of or in combination with software instructions to implement the invention. Thus, embodiments of the invention are not limited to any specific combination of hardware circuitry and software.

In an embodiment implemented using computer system 300, various machine-readable media are involved, for example, in providing instructions to processor 325 for execution. Such a medium may take many forms, including but not limited to, non-volatile media, volatile media, and transmission media. Non-volatile media includes, for example, optical or magnetic disks, such as storage device 320. Volatile media includes dynamic memory, such as main memory 310. Transmission media includes coaxial cables, copper wire and fiber optics, including the wires that comprise bus 305. Transmission media can also take the form of acoustic or light waves, such as those generated during radio-wave and infrared data communications. Various forms of machine-readable media may be involved in carrying one or more sequences of one or more instructions to processor 325 for execution.

Computer system 300 also includes a communication interface 330 coupled to bus 305. Communication interface 330 provides a two-way data communication coupling to a network link 350 that is connected to a local network 355. For example, communication interface 330 may be an integrated services digital network (ISDN) card or a modem to provide a data communication connection to a corresponding type of telephone line. As another example, communication interface 330 may be a local area network (LAN) card to provide a data communication connection to a compatible LAN. Wireless links may also be implemented. In any such implementation, communication interface 330 sends and receives electrical, electromagnetic or optical signals that carry digital data streams representing various types of information.

Network link 350 typically provides data communication through one or more networks to other data devices. For example, network link 350 may provide a connection through local network 355 to a host computer 360 or to data equipment operated by an Internet Service Provider 365. Internet Service Provider 365 in turn provides data communication services through the worldwide packet data communication network now commonly referred to as the Internet 370. Local network 355 and Internet 370 both use electrical, electromagnetic or optical signals that carry digital data streams. The signals through the various networks and the signals on network link 350 and through communication interface 330, which carry the digital data to and from computer system 300, are exemplary forms of carrier waves transporting the information.

Computer system 300 can send messages and receive data, including program code, through the network(s), network link 350 and communication interface 350. In the Internet example, a server 375 might transmit a requested code for an application program through Internet 370, ISP 365, local network 355 and communication interface 350.

The received code may be executed by processor 325 as it is received, and/or stored in storage device 320, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

5.0 Extensions and Alternatives

The foregoing invention is applicable to embodiments other than major construction projects including, but not limited to, home and building additions, remodels, improvements, repairs, education, and training, etc. The examples set forth are meant to clarify the invention and not to restrict the invention to these specific examples. As one of ordinary skill in the art would know, this invention could be applied in almost any area wherein money is aggregated for any purpose.

In the foregoing specification, the invention has been described with reference to specific embodiments thereof. It will, however, be evident that various modifications and changes may be made thereto without departing from the broader spirit and scope pf the invention. The specification and the drawing are, accordingly, to be regarded in an illustrative rather than a restrictive sense.

1. A method of automated registering of a professional contractor comprising the steps of:
logging on to a website, wherein a program on a website displays a series links;
choosing to register a building process project from the series of links;
registering the project within a provider server data base, wherein the data base contains all information for every project registered;
determining whether to register a professional for the project, wherein if a user decides not to register the professional, the user still can register the project;
registering the professional, wherein all information regarding the professional goes into the data base;
determining not to register the professional and continuing with the program;
receiving analysis results from the analysis engine, wherein the analysis results are based at least in part from data received from on one or a plurality of users registering professionals on the website; and
providing data to the provider server based on the analysis results.

2. The method of claim 1, wherein registering a professional requires paying a fee.

3. The method of claim 1, wherein requests that the professional is rated according to his performance.

4. The method of claim 1, wherein the information for each registered professional is contained in the data base for review by any person accessing the website.

5. The method of claim 1, wherein a list of registered professionals is provided for reference on future projects.

6. The method of claim 1, wherein a command set comprises one or more commands to collect data from two or more devices simultaneously.

7. The method of claim 1, wherein receiving a request from a user to access an internet Web site further comprises tracking the user's internet protocol address and storing user's information in the provider data base and wherein the analysis results are based on user session variables.

8. The method of claim 1, wherein the program is a software program.

9. A method of automated data collection and registering of construction professionals comprising the steps of:
receiving data from a Web site having a program for registering a building process project and construction related professionals uploaded from a provider server, comprising:
providing one or more Web sites displaying a series of questions for a user regarding the performance of a construction related professional, wherein a user logs on to the Web site;
providing a plurality of queries that coincide with the related professional, wherein if the user replies to the query, the data base stores the data of the related professional for the user and one or more future users;
ending the registration process for the related professional if the user determines not to register the professional; and
continuing through the registration process for the project even if the user determines not to register the professional.

10. The method according to claim 9, wherein the program is a software program.

11. The method according to claim 9, wherein registering a professional requires paying a fee.

12. The method according to claim 9, wherein a command set comprises one or more commands to collect data from two or more devices simultaneously.

13. The method according to claim 9, wherein receiving a request from a user to access an internet Web site further comprises tracking the user's internet protocol address and storing user's information in the provider data base and wherein the analysis results are based on user session variables.

14. A method of automated data collection and construction management organization from a user comprising the steps of:
receiving a request from a user machine to access an internet Web site having a program including a series of options including an organizer, wherein the Web site displays a menu which includes a project organizer;
providing a building process project organizer wherein when the user opens the organizer, a data sheet is provided for the user to complete for each project the user opens; and
providing a number for each saved project such that when a user opens the saved project a menu appears having all the project information and includes information and links for all phases of the building process project and wherein the user can switch between a phase view and a topic view of the building process project.

15. The method of claim 14, wherein the user has an option to open a new certificate course in a building process project simultaneously with opening a new project.

16. The method of claim 14, wherein the user is able to edit project details, delete projects, add users, terminate users and emails users once the project has been opened.

17. The method of claim 14, wherein the user is able to assign roles to other users, such that they can participate or make decisions or give direction or just be passive observers.

18. The method of claim 14, wherein the program is a software program.

19. The method of claim 14, wherein the building process project organizer in its topic view can contain for example including, but not limited to, scheduling; collaboration files and documentation; budgeting, estimating and calculators; bonding and insurance; productivity checklists; administrative checklists; and screening and selecting construction professionals.

20. The method of claim 19, wherein each of the above categories have several links below each related to the topic and each link either being an educational link or a tool such as a site plan review.

21. The method of claim 14, wherein the building process project organizer in its phase view can contain for example including, but not limited to, project calendar, documents and management; schematic design and scope of work phase; design development and budgeting phase; contract documents and review phase; bidding, estimating and negotiating phase; construction phase; and hiring professionals phase.

22. The method of claim 21, wherein each of the above categories have several links below each related to the topic and each link either being an educational link or a tool such as a budget calculator.
